(19) United States
(12) Patent Application Publication
(10) Pub. No.: US 2026/0269162 A1
(43) Pub. Date: Sep. 10, 2026

(54) RELAY BRANCH DEVICE MANUAL OFF AND LOCK OFF

(71) Applicant: Schneider Electric USA, Inc., Andover, MA (US)

(72) Inventor: Chad R. Mittelstadt, Cedar Rapids, IA (US)

(73) Assignee: Schneider Electric USA, Inc., Boston, MA (US)

(21) Appl. No.: 19/075,075

(22) Filed: Mar. 10, 2025

(51) Int. Cl. H01H 50/54; H01H 50/18

(52) U.S. Cl. CPC H01H 50/54; H01H 50/18

(57) ABSTRACT

A branch device circuit breaker includes a relay that includes a control coil, a stationary contact, and a moveable contact. The control coil is operatively connected to the moveable contact to control movement of the moveable contact between an open contact position and a closed contact position. The stationary contact and the moving contact are connected in series in a circuit between a line terminal and a load terminal to operate as a breaker switch controlled by electrical current in the control coil. A manual control is operatively connected to the relay to allow a user to manually actuate the circuit between an ON state with the moveable contact in the open contact position and an OFF state with the moveable contact in the closed contact position. A handle of the manual control can accommodate a range of sizes of lock hasps for locking the circuit in the OFF state.

### BACKGROUND

### 1. Field

The present disclosure relates to circuit breakers, and more particularly to branch device circuit breakers with relays.

### 2. Description of Related Art

Most circuit breaker type devices use a large handle to move the contacts to the OFF and ON state, which creates an issue in that most of the front face of the device is used and cannot be allocated for other user interface features like push buttons, LEDs, displays, labels, or the like. To add functionality to a circuit breaker, an electrical relay can be used instead of a traditional mechanical breaking mechanism. This could eliminate the need for a large handle, but off the shelf relays do not have a straightforward way to manually change contact states with a mechanical user interface such as a handle. In addition, there is no way to lock the relay device in the OFF (contacts open) state with off the shelf relays. Lastly, to lock a traditional branch device in a given state, a separate accessory need to be purchased, installed, then used which is an inconvenience for the end user.

The conventional techniques have been considered satisfactory for their intended purpose. However, there is an ever-present need for improved systems and methods for branch device circuit breakers. This disclosure provides a solution for this need.

### SUMMARY

A branch device circuit breaker includes a device body with a circuit running therethrough from a line terminal to a load terminal. A relay within the device body includes a control coil, a stationary contact, and a moveable contact. The control coil is operatively connected to the moveable contact to control movement of the moveable contact between an open contact position spaced apart from the stationary contact and a closed contact position in electrical contact with the stationary contact. The stationary contact and the moving contact are connected in series in the circuit between the line terminal and the load terminal to operate as a breaker switch controlled by electrical current in the control coil. A manual control extends from an external surface of the device body, through a wall of the device body, and into an interior space of the device body. The manual control is operatively connected to the relay to allow a user to manually actuate the circuit between an ON state with the moveable contact in the open contact position and an OFF state with the moveable contact in the closed contact position.

The relay can include a magnetic armature operatively connected to be actuated by the control coil. The magnetic armature can be operatively connected to the moveable contact to toggle the moveable contact between the closed contact position and the open contact position based on electrical current in the control coil. A link can connect the magnetic armature to the moveable contact. Movement of the link can be predominantly linear and can be along an actuation axis between the open contact position and the closed contact position.

The manual control can include a slider that is slidingly engaged within the device body to slide relative to the relay parallel to the actuation axis. A first end of the slider can be operatively connected to the link to mechanically actuate the moveable contact from an ON position, corresponding to the ON state, to the OFF position, corresponding to the OFF state, based on position of the slider within the device body.

The manual control can include a handle engaged to a second end of the slider. The handle can be slidingly engaged to the device body to slide in a direction perpendicular to the actuation axis. The handle can extend from the exterior surface the device body, through the wall of the device body to the interior space of the device body. In the OFF position, the handle can protrude more from the external surface of the device body than in the ON position. The handle can include a hasp bore therethrough configured to receive a hasp of a lock for locking the moveable contact in the OFF position. The device body can occlude the hasp bore with the handle in the ON position. The hasp bore can be clear of the device body and accessible to receive a hasp in the OFF position.

The handle can include a camming pin and the second end of the slider can include a camming track. Force from movement of the handle can transfer to the slider through sliding of the camming pin along the camming track. The camming track can include a first portion extending perpendicular to the actuation axis for movement of the handle perpendicular to the actuation axis without movement of the slider to accommodate a range of hasp sizes in the hasp bore with the moveable contact fully in the open contact position. The camming track can include a second portion extending oblique to the actuation axis for mechanical transfer of motion of the handle perpendicular to the actuation axis into motion of the slider parallel to the actuation axis. The second portion of the camming track can be oblique to the actuation axis at a 45° angle for 1:1 transfer of motion from the handle to the slider.

The manual control can include a handle that is slidingly engaged to the device body to slide in a direction perpendicular to an interface side of the device body. The handle can extend from the exterior surface the device body, through the wall of the device body to the interior space of the device body. In an OFF position corresponding to the OFF state, the handle can protrude more from the external surface of the device body than in an ON position corresponding to the ON state. The handle can have a stroke relative to the device body. For a first portion of the stroke as the handle goes from a fully extended OFF position toward the ON position, movement of the handle perpendicular to the actuation axis can occur without movement of the moveable contact to accommodate a range of hasp sizes in a hasp bore through the handle with the moveable contact fully in the open contact position throughout the first portion of the stroke. For a second portion of the stroke of the handle going from the OFF position to the ON position of the handle, there can be a mechanical transfer of motion of the handle to the moveable contact.

A neutral line can run through the device body from a panel neutral terminal to a load neutral terminal. The line terminal and the panel neutral terminal can be on a bus connector side of the device body. The load terminal and the load neutral terminal can be on a lug side of the device body opposite the bus connector side of the device body. A controller can be operatively connected to control the relay based on commands received by the controller and/or based on sensor feedback indicative of a fault in the circuit. The controller can be inside the device body. A controller connector can extend through the device body to connect the controller to a data bus. The controller connector can extend from the bus connector side of the device body. The device body can include an interface side between the bus connector side and the lug side. The interface side can include an input/output (IO) interface.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a perspective view of an embodiment of a branch device circuit breaker constructed in accordance with the present disclosure, showing the device body and manual control handle in the OFF position;

FIG. 2 is a perspective view of the branch device circuit breaker of FIG. 1, showing the manual control handle in the ON position;

FIG. 3 is a cross-sectional side elevation view of the branch device circuit breaker of FIG. 1, showing the moveable contact and the stationary contact of the relay spaced apart in the OFF state;

FIG. 4 is a cross-sectional side elevation view of the branch device circuit breaker of FIG. 1, showing the moveable contact and the stationary contact of the relay contacting one another in the ON state;

FIG. 5 is a cross-sectional side elevation view of the relay of FIG. 3, showing a link extending outside the relay body for manual control;

FIG. 6 is a perspective view of the relay of FIG. 5, showing the portion of the link outside the relay body;

FIG. 7 is a perspective view of a portion of the branch device circuit breaker of FIG. 1, showing the handle and a slider of the manual control;

FIG. 8 is an exploded perspective view of the handle and slider of FIG. 7, showing the camming pin and the camming track;

FIG. 9 is a cross-sectional side elevation view of the branch device circuit breaker of FIG. 1, showing the handle in a portion of the manual control stroke that moves the slider;

FIG. 10 is a cross-sectional side elevation view of the branch device circuit breaker of FIG. 9, showing the handle in a portion of the manual control stroke that does not move the slider;

FIG. 11 is a cross-sectional perspective view of the branch device circuit breaker of FIG. 1, showing a lock with a relatively small hasp locking the handle in the OFF position; and

FIG. 12 is a cross-sectional perspective view of the branch device circuit breaker of FIG. 1, showing a lock with a relatively large hasp locking the handle in the OFF position.

### DETAILED DESCRIPTION OF THE PREFERRED EMBODIMENTS

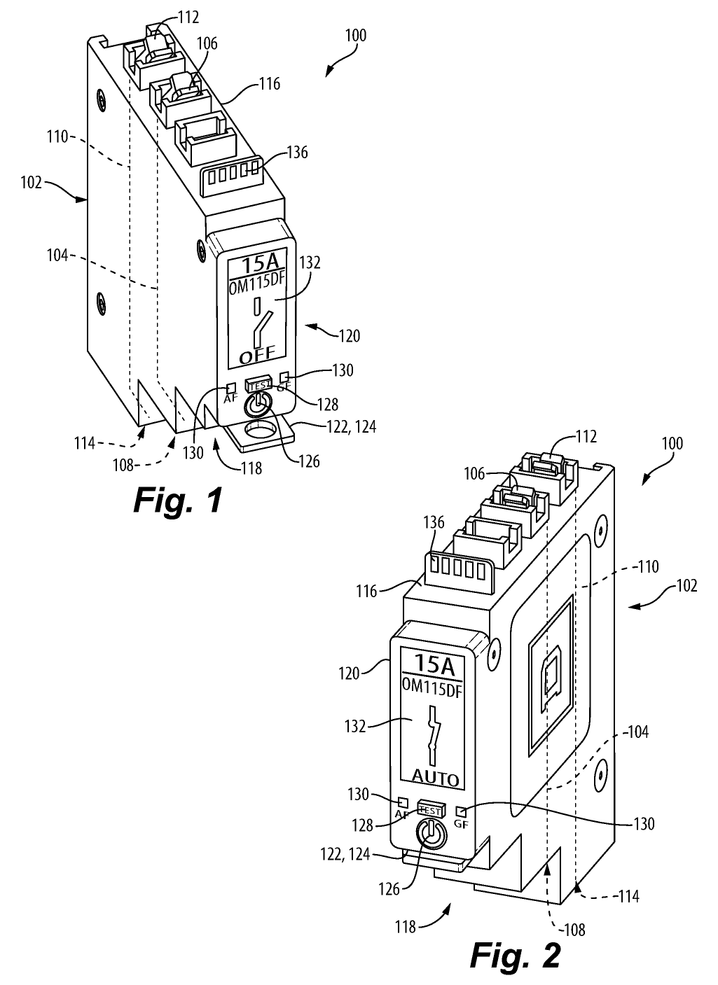

Reference will now be made to the drawings wherein like reference numerals identify similar structural features or aspects of the subject disclosure. For purposes of explanation and illustration, and not limitation, a partial view of an embodiment of a branch device circuit breaker in accordance with the disclosure is shown in FIG. 1 and is designated generally by reference character 100. Other embodiments of systems in accordance with the disclosure, or aspects thereof, are provided in FIGS. 2-12, as will be described. The systems and methods described herein can be used to provide relay-based branch device circuit breakers with manual OFF and lock OFF capability.

The branch device circuit breaker 100 includes a device body 102 with a circuit 104 running therethrough from a line terminal 106 to a load terminal 108. A neutral line 110 runs through the device body 102 from a panel neutral terminal 112 to a load neutral terminal 114. In FIGS. 1-2, the circuit 104 and neutral line 110 are hidden, so are shown schematically with broken lines. The line terminal 106 and the panel neutral terminal 112 are on a bus connector side 116 of the device body 102. The load terminal 108 and the load neutral terminal 114 are on a lug side 118 of the device body 102 opposite the bus connector side 116. The device body 102 includes an interface side 120 between the bus connector side 116 and the lug side 118. The branch device circuit breaker 100 includes a manual control 122, the handle 124 of which is shown in FIG. 1 in the OFF position and in FIG. 2 in the ON position. The interface side 120 includes the handle 124, an input/output (IO) interface including an on/off button 126, a test button 128, LEDs 130, and/or a display 132, none of which are covered, obscured, or occluded by the handle 124, regardless of whether it is in the ON or OFF position.

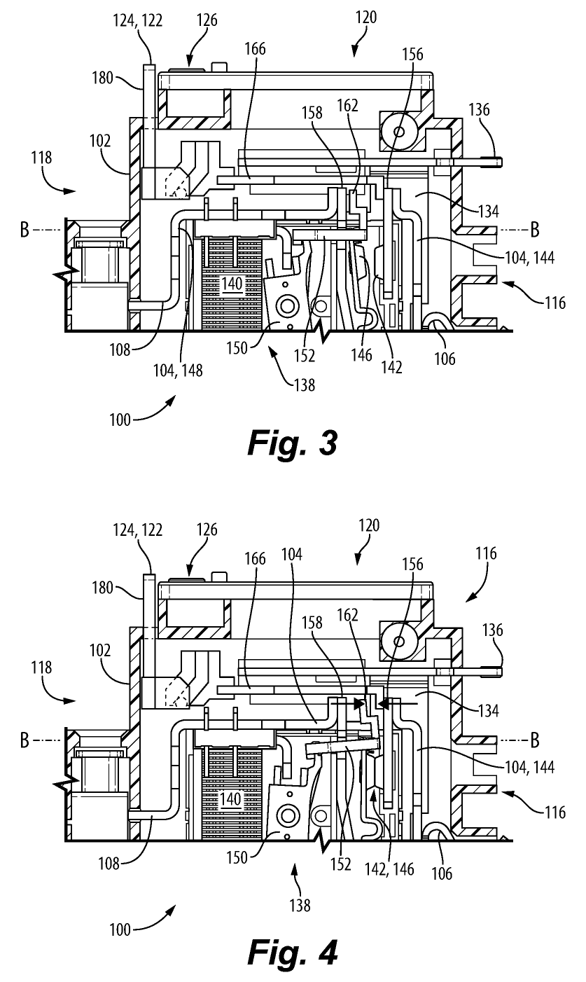

With reference now to FIGS. 3-4, a controller 134, e.g., a microcontroller unit (MCU) on a printed circuit board assembly (PCBA), is inside the device body 102, with a controller connector 136 that extends through the device body 102 to connect the controller 134 to a data bus, e.g., in a breaker box interior. The controller connector 136 extends from the bus connector side 116 of the device body 102. The controller 134 is operatively connected to control a circuit breaking relay 138 within the device body 102 based on commands, e.g., user input or automated system input, received by the controller 134 and/or based on sensor feedback to the controller 134 indicative of a fault in the circuit 104.

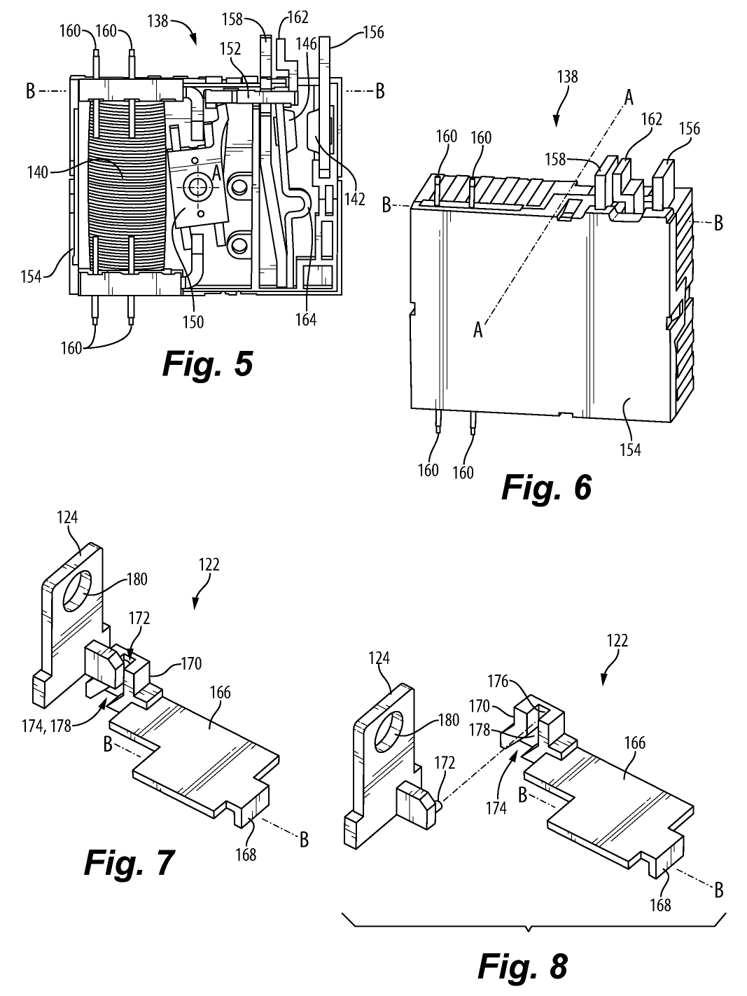

With reference now to FIG. 5, the relay 138 includes a control coil 140, a stationary contact 142 electrically connected to a line side 144 of the circuit 104 (as shown in FIG. 3), and a moveable contact 146 electrically connected to a load side 148 of the circuit 104 (as shown in FIG. 3), although the sides of the circuit 104 could optionally be reversed. The control coil 140 is operatively connected to the moveable contact 146 by a magnetic armature 150 and link 152 to control movement of the moveable contact 146 between an open contact position spaced apart from the stationary contact 142 as shown in FIG. 3 and a closed contact position in electrical contact with the stationary contact 142 as shown in FIG. 4. The stationary contact 142 and the movable contact 146 are connected in series in the circuit 104 between the line terminal 106 and the load terminal 108 to operate as a breaker switch controlled by electrical current in the control coil. FIG. 3 shows the relay contacts open and FIG. 4 shows them closed, both with the handle of the manual control 122 in the ON position as when the branch device circuit breaker 100 is operating under control by the controller 134 rather than manual control.

The magnetic armature 150 is operatively connected to be actuated by the control coil 140 using magnetic forces from a magnetic field generated by electrical current in the control coil 140. The magnetic armature 150 toggles about an armature axis A and is operatively connected to the moveable contact 146 to toggle the moveable contact 146 between the closed contact position of FIG. 4 and the open contact position of FIG. 3 depending on electrical current in the control coil 140. The link 152 mechanically connects the magnetic armature 150 to the moveable contact 146 such that movement of the link 152 is predominantly linear and is along an actuation axis B between the open contact position and the closed contact position shown in FIGS. 3-4, respectively. A biasing member 164 can apply a biasing force to the moveable contact 146 to hold the moveable contact 146 in the open contact position shown in FIG. 5 in the absence of magnetic forces in the control coil 140.

An optional relay body 154 houses the control coil 140, magnetic armature 150, link 152, and contacts 142, 146. Terminals 156, 158 of the contacts 142, 146, respectively, extend from inside the relay body 154 to outside where they can be connected to the circuit 104 as shown in FIGS. 3-4. Electrical connectors 160 extend from the control coil 140, through the relay body 154, to the outside for electrical connection of the controller 134 (labeled in FIG. 3) to the control coil 140. The link 152 includes a mechanical connector 162 that extends outside of the relay body 154 for use in manual control of the contacts 142, 146. FIG. 5 shows the portions of the connectors 160, terminals 156, 158, and mechanical connector 162 that extend outside of the relay body 154.

With reference again to FIG. 3, the handle 124 of the manual control 122 extends from an external surface, e.g., interface side 120, of the device body 102, through a wall of the device body 102, and into the interior space of the device body 102. The manual control 122 is operatively connected to the relay 138 to allow a user to manually actuate the circuit 104 between states from an ON state of FIG. 4 with the moveable contact 146 in the open contact position to an OFF state shown in FIG. 3 with the moveable contact 146 in the closed contact position. The manual control 122 includes a slider 166 that is slidingly engaged within the device body 102 to slide relative to the relay 138 and device body 102 parallel to the actuation axis B. A first end 168 of the slider 166 is operatively connected to the mechanical connector 162 of the link 152 to mechanically actuate the moveable contact 146 from an ON position as in FIG. 4, corresponding to the ON state, to the OFF position shown in FIG. 3, corresponding to the OFF state, based on position of the slider 166 within the device body 102. A gap, identified in FIG. 4, accommodates automatic movement of the moveable contact 146 to the open or closed contact positions as long as the handle 124 is in the ON position.

The handle 124 is engaged to a second end 170 of the slider 166. The handle 124 is slidingly engaged to the device body 102 to slide in a direction perpendicular to the interface side 120 of the device body, which is itself aligned parallel to the actuation axis B. The handle 124 extends from the exterior surface, e.g., the interface side 120 the device body 102, through the wall of the device body 102 to the interior space of the device body 102.

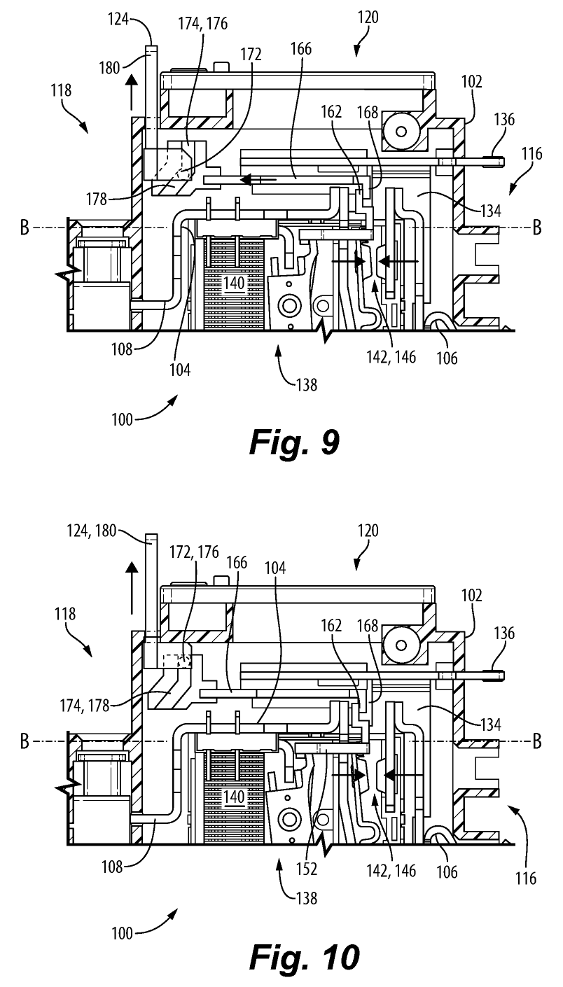

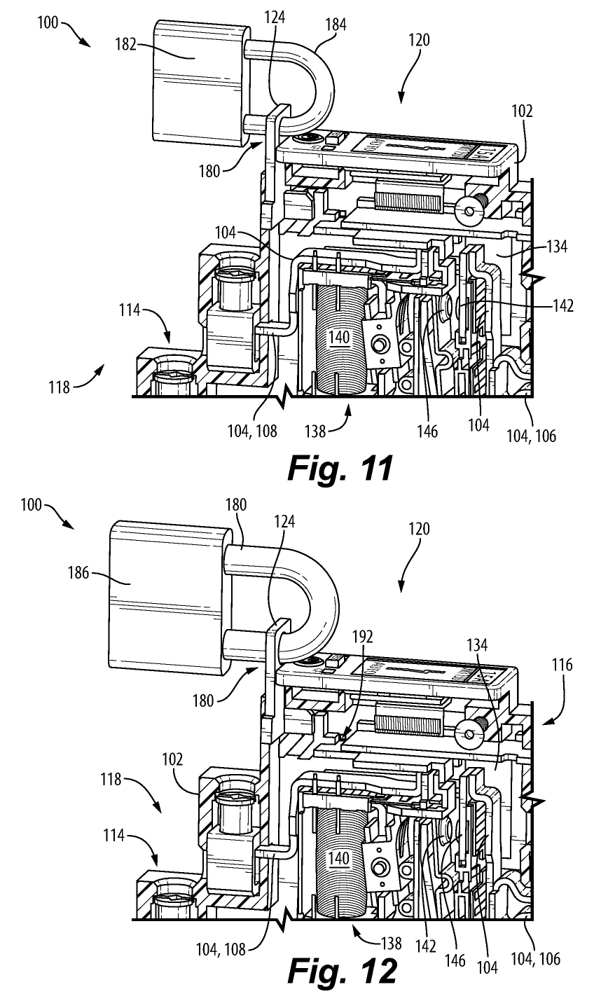

With reference now to FIGS. 7-8, the handle 124 includes a camming pin 172 and the second end 170 of the slider 166 includes a camming track 174 shown engaged to one another in FIG. 7 and separate from one another in FIG. 8. Force from movement of the handle 124, in the vertical direction as oriented in FIG. 9, transfers to the slider 166 through sliding of the camming pin 172 along the camming track 174. The camming track 174 includes a first portion 176, corresponding to a first portion of the stroke of the handle 124 as the handle 124 goes from the fully extended OFF position of the handle 124 shown in FIG. 10 toward the ON position of the handle 124 shown in FIGS. 3-4. The first portion 176 of the camming track 174 extends perpendicular to the actuation axis B, e.g., the first portion 176 is vertical as oriented in FIGS. 9-10, for movement of the handle 124 perpendicular to the actuation axis B without any movement of the slider 166. The lack of motion of the slider 166 in this first part of the stroke of the handle 124 allows the handle 124 to accommodate a range of hasp sizes in the hasp bore 180 of the handle 124 with the moveable contact 146 fully in the open contact position. FIGS. 11 and 12 show a lock 182 with a relatively small gage hasp 184 in the hasp bore 180 in FIG. 11, and a lock 186 with a relatively large gage hasp 188 in the hasp bore 180 in FIG. 12. Notwithstanding the difference in hasp sizes in FIGS. 11 and 12, the moveable contact 146 is in its fully open position in both FIGS. 11 and 12.

Returning again to FIGS. 7-10, the camming track 174 includes a second portion 178, corresponding to a second portion of the stroke of the handle 124 going from the OFF position to the ON position of the handle 124. The second portion 178 of the camming track 174 extends oblique to the actuation axis B, e.g. at a 45° or so, for mechanical transfer of motion of the handle 124, e.g. in the vertical direction as oriented in FIGS. 9-10, perpendicular to the actuation axis B into motion of the slider 166 parallel to the actuation axis B and corresponding movement of the moveable contact 146. The slider 166 can be biased, e.g. spring loaded, toward the ON position to avoid coming to rest in an intermediate position when not actuated to the OFF position. If the second portion 178 of the camming track 174 is oblique to the actuation axis at a 45° angle, in the second portion of the stroke of the handle 124, there will be a 1:1 transfer of motion vertical motion from the handle 124 to horizontal motion of the slider 166 as oriented in FIGS. 9-10.

The stroke of the handle 124 is relative to the device body 102. In the OFF position, shown in FIG. 10, the handle 124 protrudes more from the external surface, e.g., the interface side 120 of the device body 102, than in the ON position shown in FIGS. 3-4. The hasp bore 180 is not only configured to receive a hasp of a lock but is also configured for allowing a user to grip, e.g., with a finger, the handle 124 for moving the moveable contact in the OFF position, and optionally locking the handle 124 in the locked position as shown in FIGS. 11-12. The device body 102 occludes the hasp bore 180 with the handle in the ON position as shown in FIGS. 3-4 so a lock hasp cannot pass through the hasp bore 180, but a user can still access the hasp bore 180 as a grip to pull the handle 124 toward the OFF and LOCKED positions. The hasp bore 180 is clear of the device body 102 and accessible to receive a hasp in the OFF position as shown in FIG. 10.

Systems and methods as disclosed herein provide potential benefits including the following. Combining the relay-controlled breaker operation with mechanical manual control provides the functional advantages of automatic and/or remote control, and with the mechanical aspects of a local external switch needed to facilitate meeting with code requirements. The configurations disclosed herein allow for both OFF and locked OFF states. The motion and configuration of the handle 124 leaves open space on interface side 120 for display, indicia, or the like, with little or no obstruction from a switch handle. An optional microswitch 192, labeled in FIG. 12, can give feedback to the controller 134 to know position of mechanism of the manual control 122.

The methods and systems of the present disclosure, as described above and shown in the drawings, provide for relay-based branch device circuit breakers with manual OFF and lock OFF capability. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A branch device circuit breaker comprising:
a device body with a circuit running therethrough from a line terminal to a load terminal;
a relay within the device body, the relay including a control coil, a stationary contact, and a moveable contact, wherein the control coil is operatively connected to the moveable contact to control movement of the moveable contact between an open contact position spaced apart from the stationary contact and a closed contact position in electrical contact with the stationary contact, wherein the stationary contact and the moving contact are connected in series in the circuit between the line terminal and the load terminal to operate as a breaker switch controlled by electrical current in the control coil; and
a manual control extending from an external surface of the device body, through a wall of the device body, and into an interior space of the device body, wherein the manual control is operatively connected to the relay to allow a user to manually actuate the circuit between an ON state with the moveable contact in the open contact position and an OFF state with the moveable contact in the closed contact position.

2. The branch device circuit breaker as recited in claim 1, wherein the relay includes a magnetic armature operatively connected to be actuated by the control coil, wherein the magnetic armature is operatively connected to the moveable contact to toggle the moveable contact
between the closed contact position and the open contact position based on electrical current in the control coil.

3. The branch device circuit breaker as recited in claim 2, wherein a link connects the magnetic armature to the moveable contact, wherein movement of the link is predominantly linear and is along an actuation axis between the open contact position and the closed contact position.

4. The branch device circuit breaker as recited in claim 3, wherein the manual control includes a slider that is slidingly engaged within the device body to slide relative to the relay parallel to the actuation axis, wherein a first end of the slider is operatively connected to the link to mechanically actuate the moveable contact from an ON position, corresponding to the ON
state, to the OFF position, corresponding to the OFF state, based on position of the slider within the device body.

5. The branch device circuit breaker as recited in claim 4, wherein the manual control includes a handle engaged to a second end of the slider, wherein the handle is slidingly engaged
to the device body to slide in a direction perpendicular to the actuation axis.

6. The branch device circuit breaker as recited in claim 5, wherein the handle extends from the exterior surface the device body, through the wall of the device body to the interior space of the device body.

7. The branch device circuit breaker as recited in claim 6, wherein in the OFF position, the handle protrudes more from the external surface of the device body than in the ON position.

8. The branch device circuit breaker as recited in claim 7, wherein the handle includes a hasp bore therethrough configured to receive a hasp of a lock for locking the moveable contact in the OFF position.

9. The branch device circuit breaker as recited in claim 8, wherein the device body occludes the hasp bore with the handle in the ON position, and wherein the hasp bore is clear of the device body and accessible to receive a hasp in the OFF position.

10. The branch device circuit breaker as recited in claim 9, wherein the handle includes a
camming pin, and wherein the second end of the slider includes a camming track, wherein force from movement of the handle transfers to the slider through sliding of the camming pin along the camming track.

11. The branch device circuit breaker as recited in claim 10, wherein the camming track
includes a first portion extending perpendicular to the actuation axis for movement of the handle perpendicular to the actuation axis without movement of the slider to accommodate a range of hasp sizes in the hasp bore with the moveable contact fully in the open contact position.

12. The branch device circuit breaker as recited in claim 11, wherein the camming track
includes a second portion extending oblique to the actuation axis for mechanical transfer of motion of the handle perpendicular to the actuation axis into motion of the slider parallel to the actuation axis.

13. The branch device circuit breaker as recited in claim 12, wherein the second portion of the camming track is oblique to the actuation axis at a 45° angle for 1:1 transfer of motion from the handle to the slider.

14. A branch device circuit breaker comprising:
a device body with a circuit running therethrough from a line terminal to a load terminal;
a relay within the device body, the relay including a control coil, a stationary contact, and
a moveable contact, wherein the control coil is operatively connected to the moveable contact to control movement of the moveable contact between an open contact position spaced apart from the stationary contact and a closed contact position in electrical contact with the stationary contact, wherein the stationary contact and the moving contact are connected in series in the circuit between the line terminal and the load terminal to operate as a breaker switch controlled by electrical current in the control coil; and
a manual control extending from an external surface of the device body, through a wall of the device body, and into an interior space of the device body, wherein the manual control is operatively connected to the relay to allow a user to manually actuate the circuit between an ON state with the moveable contact in the open contact position and an OFF state with the moveable contact in the closed contact position, wherein the manual control includes a handle that is slidingly engaged to the device body to slide in a direction perpendicular to an interface side of the device body, wherein the handle extends from the exterior surface the device body, through the wall of the device body to the interior space of the device body, wherein in an OFF position corresponding to the OFF state, the handle protrudes more from the external surface of the device body than in an ON position corresponding to the ON state.

15. The branch device circuit breaker as recited in claim 14, wherein the handle has a stroke relative to the device body, wherein for a first portion of the stroke as the handle goes from a fully extended OFF position toward the ON position, movement of the handle perpendicular to
the actuation axis occurs without movement of the moveable contact to accommodate a range of hasp sizes in a hasp bore through the handle with the moveable contact fully in the open contact position throughout the first portion of the stroke.

16. The branch device circuit breaker as recited in claim 15, wherein for a second portion of
the stroke of the handle going from the OFF position to the ON position of the handle, there is a mechanical transfer of motion of the handle to the moveable contact.

17. The branch device circuit breaker as recited in claim 1, further comprising a neutral line running through the device body from a ground terminal to a return terminal.

18. The branch device circuit breaker as recited in claim 17, wherein the line terminal and the panel neutral terminal are on a bus connector side of the device body, and wherein the load terminal and the load neutral terminal are on a lug side of the device body opposite the bus connector side of the device body.

19. A branch device circuit breaker comprising:
a device body with a circuit running therethrough from a line terminal to a load terminal;
a relay within the device body, the relay including a control coil, a stationary contact, and
a moveable contact, wherein the control coil is operatively connected to the moveable contact to control movement of the moveable contact between an open contact position spaced apart from the stationary contact and a closed contact position in electrical contact with the stationary
contact, wherein the stationary contact and the moving contact are connected in series in the circuit between the line terminal and the load terminal to operate as a breaker switch controlled by electrical current in the control coil;
a manual control extending from an external surface of the device body, through a wall of the device body, and into an interior space of the device body, wherein the manual control is operatively connected to the relay to allow a user to manually actuate the circuit between an ON state with the moveable contact in the open contact position and an OFF state with the moveable contact in the closed contact position;
a neutral line running through the device body from a ground terminal to a return terminal, wherein the line terminal and the panel neutral terminal are on a bus connector side of the device body, and wherein the load terminal and the load neutral terminal are on a lug side of the device body opposite the bus connector side of the device body; and
a controller operatively connected to control the relay based on commands received by the controller and/or based on sensor feedback indicative of a fault in the circuit, wherein the controller is inside the device body, and wherein a controller connector extends through the device body to connect the controller to a data bus, wherein the controller connector extends from the bus connector side of the device body.

20. The branch device circuit breaker as recited in claim 19, wherein the device body includes an interface side between the bus connector side and the lug side, wherein the interface side includes an input/output (IO) interface.
